(19) United States
(12) Patent Application Publication
(10) Pub. No.: US 2012/0256964 A1
(43) Pub. Date: Oct. 11, 2012

(54) INFORMATION PROCESSING DEVICE, INFORMATION PROCESSING METHOD, AND PROGRAM STORAGE MEDIUM

(75) Inventors: Makoto Hirota, Tokyo (JP); Motoki Nakama, Kawasaki-shi (JP)

(73) Assignee: CANON KABUSHIKI KAISHA, Tokyo (JP)

(21) Appl. No.: 13/434,534

(22) Filed: Mar. 29, 2012

(30) Foreign Application Priority Data
Apr. 5, 2011 (JP) 2011-084020

(51) Int. Cl. G09G 5/00

(52) U.S. Cl. 345/666

(57) ABSTRACT

An information processing method enlarges or reduces and displays an area of a part of image data, displayed on a display unit, in response to a user's operation and determines, based on objects included in the enlarged or reduced and displayed area and on objects included in a plurality of image data pieces, a display order of the plurality of image data pieces.

### BACKGROUND OF THE INVENTION

1. Field of the Invention

The present invention relates to a technology for displaying image data related to a region of user's interest.

2. Description of the Related Art

A recent trend toward a small-size, large-capacity internal memory, such as the one used in a digital camera, allows a large amount of image data to be accumulated. This increases the accumulation amount of image data that was imaged in the past, generating a problem that the user has to spend a long time searching for desired image data from a large amount of image data.

To solve this problem, Japanese Patent Application Laid-Open No. 2010-211785 discusses a technology for increasing the efficiency of searching for photographs that contain the same face by detecting the face region in each photograph and grouping photographs based on the similarity in the face region.

The technology discussed in Japanese Patent Application Laid-Open No. 2010-211785 can result in that, if the faces of a plurality of persons are included in a photograph but the interested person is only one of them, the photographs including other person's faces may be grouped into the same group. Grouping the photographs in this way sometimes can make it difficult to search for the photographs including persons who are a target of interest.

### SUMMARY OF THE INVENTION

One aspect of the present invention is directed to a technology for displaying image data related to a region of user's interest without cumbersome operations.

According to an aspect of the present invention, an information processing device includes a memory and a processor, coupled to the memory, wherein the processor controls a display control unit configured to enlarge or reduce and display an area of a part of image data, displayed on a display unit, in response to a user operation, and a determination unit configured to, based on objects included in the area enlarged or reduced and displayed by the display control unit and on objects included in a plurality of image data pieces, determine a display order of the plurality of image data pieces.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A, 1B, and 1C are diagrams illustrating the configuration of a mobile terminal that is an information processing device in a first exemplary embodiment of the present invention.

FIGS. 2A and 2B are diagrams illustrating image data of display target in the first exemplary embodiment.

FIG. 3 is a diagram illustrating an example of metadata on each image data held in the holding unit.

FIG. 4 is a flowchart illustrating the processing for displaying image data on a touch panel according to a user operation.

FIG. 5 is a flowchart illustrating the matching degree calculation processing.

FIG. 6 is a diagram illustrating the relation between the storage state of image data in the cache and the display state of image data.

FIGS. 7A and 7B are diagrams illustrating examples of pinch operation on image data.

FIG. 8 is a flowchart illustrating the processing when object recognition is executed at image data browsing time.

FIGS. 9A and 9B are diagrams illustrating a second exemplary embodiment of the present invention.

FIG. 10 is a diagram illustrating the display in which a part of persons is displayed when image data is enlarged and displayed.

FIG. 11 is a diagram illustrating examples of metadata attached to image data.

FIG. 12 is a diagram illustrating a third exemplary embodiment of the present invention.

FIGS. 13A and 13B are diagrams illustrating a fourth exemplary embodiment of the present invention.

FIG. 14 is a diagram illustrating a fifth exemplary embodiment of the present invention.

### DESCRIPTION OF THE EMBODIMENTS

Various exemplary embodiments, features, and aspects of the invention will be described in detail below with reference to the drawings.

For description purposes, a first exemplary embodiment of the present invention will refer to a mobile phone as an example of an information processing device. In addition, in the first exemplary embodiment, for discussion purposes, image data is the digital data of a photograph and that an object in the image data are persons in the photograph. Finally, again for description purposes, information on the persons in the photograph is added in advance to the image data as metadata. The following describes a case where a user browses image data on a mobile terminal.

In browsing the image date, the user performs a flick operation with the user's finger(s) to move the image data horizontally, e.g., right to left or left to right in order to browse various types of image data. The flick operation refers to the user sliding a finger on a touch panel of a display to move the image data in a horizontal direction. The user can also perform a pinch operation using the user's fingers to enlarge or reduce a displayed image. The pinch operation refers to the user sliding, in opposite directions, at least two fingers on the touch panel to enlarge or reduce the image.

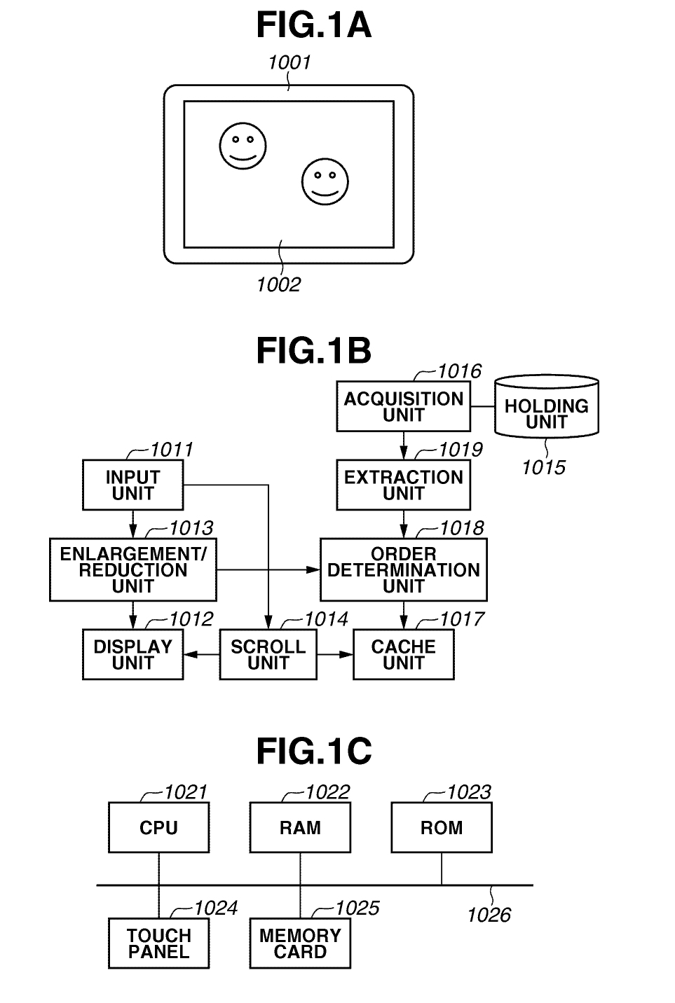

FIGS. 1A, 1B, and 1C are diagrams illustrating the configuration of a mobile terminal, which as described above is being used as an example of an information processing device, according to the first exemplary embodiment. FIG. 1A is a diagram illustrating the external view of the mobile terminal. FIG. 1B is a diagram illustrating the functional configuration of the mobile terminal. FIG. 1C is a diagram illustrating the hardware configuration of the mobile terminal.

FIG. 1A shows a mobile terminal 1001. The mobile terminal 1001 includes a touch panel (Liquid Crystal Display (LCD)) 1002.

In FIG. 1B, an input unit 1011, a unit that accepts a touch input to the touch panel 1002, can accept a multi-touch input. A display unit 1012 displays image data on the touch panel 1002. An enlargement/reduction unit 1013 controls the display control operation of the display unit 1012 to enlarge or reduce displayed image data in response to a multi-touch pinch operation on the touch panel 1002.

A scroll unit 1014 moves image data horizontally via a flick operation on the touch panel 1002. A holding unit 1015 holds a plurality of image data pieces. An acquisition unit 1016 acquires image data from the holding unit 1015. A cache unit 1017 holds image data, which will be preferentially displayed according to a display order, in a Random Access Memory (RAM) 1022. An order determination unit 1018 determines the order in which image data held in the RAM 1022 is to be displayed. An extraction unit 1019 extracts information on a person in the image data from metadata, attached to image data to identify the person in the image data.

In FIG. 1C, a central processing unit (CPU) 1021 executes a program for implementing the operational procedure of the mobile terminal 1001. The RAM 1022 provides a storage area for the operation of the program described above. A read only memory (ROM) 1023 holds the program described above. A touch panel 1024 is an input device that allows the user to enter a command. A memory card 1025 is a card in which image data is recorded. A bus 1026 is a bus via which the components described above are connected with one another.

The CPU 1021 loads the above-described program from the ROM 1023 to the RAM 1022 for executing the program therein to implement the input unit 1011, enlargement/reduction unit 1013, display unit 1012, scroll unit 1014, acquisition unit 1016, cache unit 1017, order determination unit 1018, and extraction unit 1019. The holding unit 1015 corresponds to the memory card 1025. The touch panel 1024 corresponds to the touch panel 1002 shown in FIG. 1.

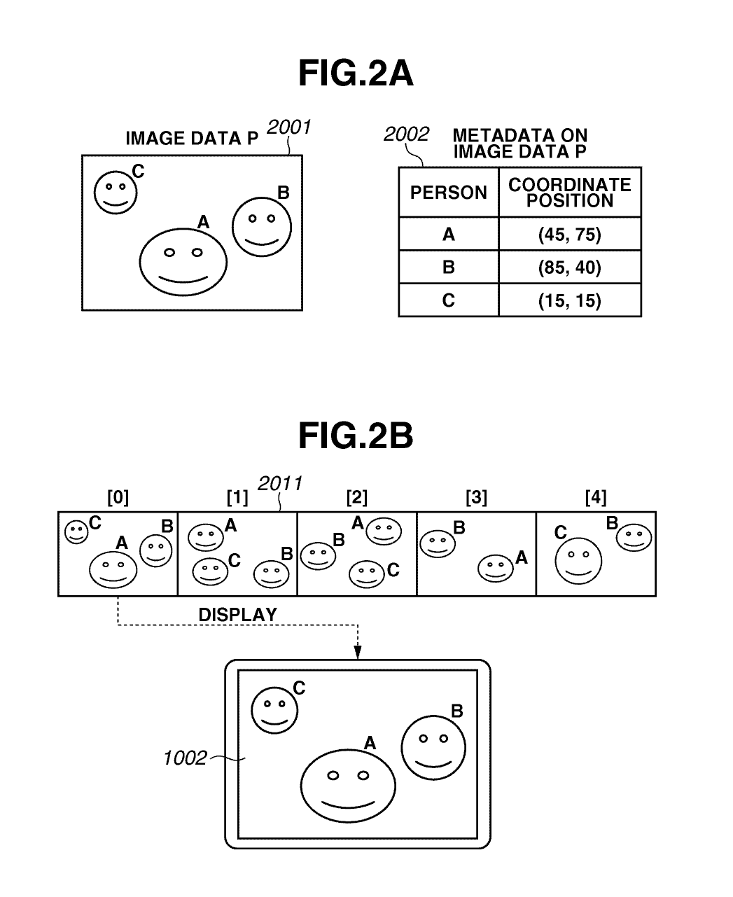

FIG. 2A is a diagram illustrating image data P 2001 stored in the holding unit 1015 and metadata 2002 attached to the image data P 2001. The metadata 2002 includes information (A, B, C) that identifies the persons in the image data P 2001 and the coordinate positions of the persons in the image data P 2001. The coordinate position is a value wherein the x-coordinate of the right-end is 100 and the y-coordinate of the bottom end is 100 with the top-left corner of the image data P 2001 as the origin.

FIG. 2B is a diagram illustrating the relation between the storage state of image data in the RAM 1022 and the display state of the image data on the touch panel 1002 (1024). The cache unit 1017 manages a cache 2011 that is a part of the storage area in the RAM 1022. The cache unit 1017 acquires a plurality of image data pieces from the holding unit 1015 via the acquisition unit 1016 and writes the image data in one of the positions [0], [1], [2], [3], and [4] in the cache 2011, one for each. The display unit 1012 displays image data P, written in the position [0] in the cache 2011, on the touch panel 1002. The order determination unit 1018 determines the order of the image data, stored in the cache 2011, based on the metadata.

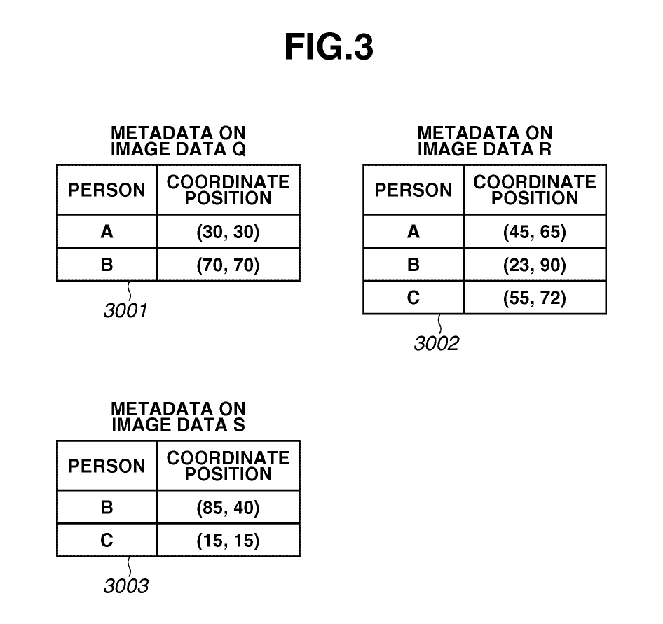

FIG. 3 is a diagram illustrating an example of the metadata of each image data stored in the holding unit 1015. FIG. 3 shows that the holding unit 1015 stores metadata 3001 of image data Q, metadata 3002 of image data R, and metadata 3003 of image data S. As shown in FIG. 2A, the image data P includes persons A, B, and C. On the other hand, the metadata 3001 in FIG. 3 indicates that the image data Q includes persons A and B. In this case, the acquisition unit 1016 calculates the recall based on the number of persons who are included in the image data P and who are included also in the image data Q. The acquisition unit 1016 acquires (first acquisition) the information on the number of persons who are included in the image data P and who are also included in the image data Q and calculates the recall as follows:

Recall=2 persons (=A,B)/3 persons (=number of persons in image data P)=2/3

In addition, the acquisition unit 1016 calculates the precision based on the number of persons who are included in the image data Q and who are also included in the image data P. The acquisition unit 1016 acquires (second acquisition) the information on the number of persons who are included in the image data Q and who are also included in the image data P and calculates the precision as follows:

Precision=2 persons (=A,B)/2 persons (=number of persons in image data Q)=1

After that, the acquisition unit 1016 calculates the matching degree between the image data P and the image data Q using the product of the recall and the precision as follows:

Matching degree between image data P and image data Q=Recall×Precision=2/3×1=2/3

Similarly, the acquisition unit 1016 calculates the matching degree between the image data P and the image data R and the matching degree between the image data P and the image data S as follows:

Matching degree between image data P and image data R=3/3×3/3=1

Matching degree between image data P and image data S=2/3×2/2=2/3

From the image data stored in the holding unit 1015, the acquisition unit 1016 acquires only the image data whose matching degree calculated as described above is greater than or equal to the threshold (for example, greater than or equal to ½). After that, the order determination unit 1018 stores the image data, acquired by the acquisition unit 1016, sequentially in the positions [0], [1], [2], [3], and [4] in the cache 2011 in descending order of the matching degree.

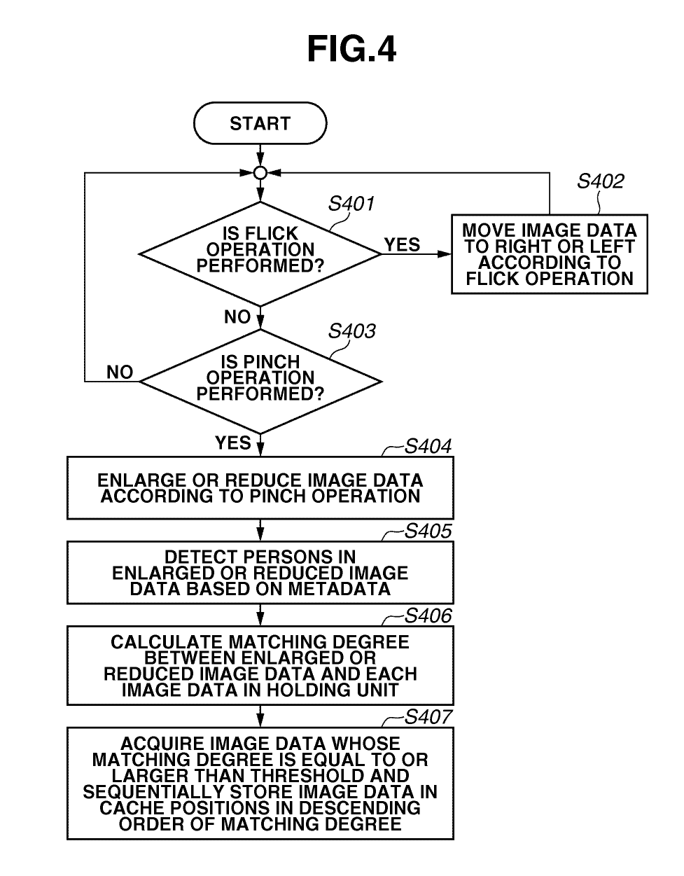

Next, with reference to the flowchart in FIG. 4, the following describes the processing of displaying image data on the touch panel 1002 in response to a user operation. In step S401, the input unit 1011 determines if the user performs the flick operation on the touch panel 1002. If the user performs the flick operation (YES in step S401), the processing proceeds to step S402. On the other hand, if the user does not perform the flick operation (No in step S401), the processing proceeds to step S403.

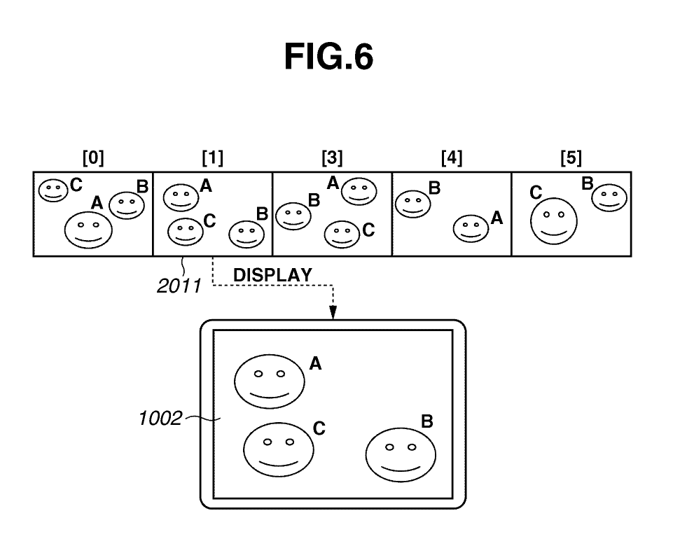

In step S402, the display unit 1012 moves the image data horizontally according to the user's flick operation. For example, when the user flicks left with the image data P (image data in the position [0] in the cache 2011) displayed, the display unit 1012 moves the displayed image data P to the left until it is no longer visible on the screen. At the same time, the display unit 1012 moves the image data in the position [1] in the cache 2011 into the screen from the right end of the screen and displays it in the center, as shown in FIG. 6.

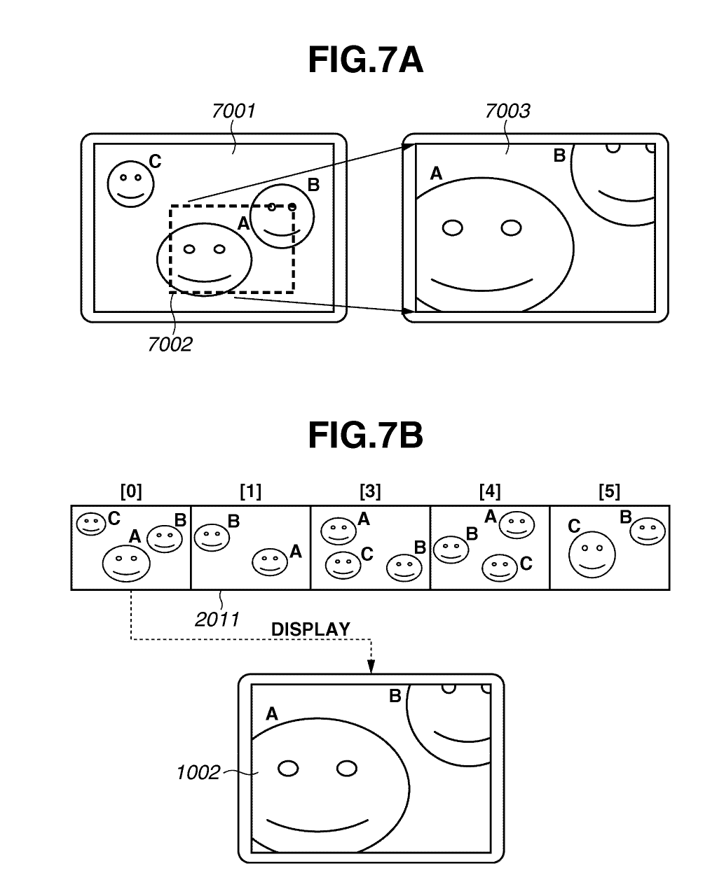

In step S403, the input unit 1011 determines whether the user performs the pinch operation on the displayed image data P. If the user performs the pinch operation (YES in step S403), the processing proceeds to step S404. On the other hand, if the user does not perform the pinch operation (NO in step S403), the processing returns to step S401. In step S404, the enlargement/reduction unit 1013 enlarges or reduces the image data according to the pinch operation and the display unit 1012 displays the enlarged or reduced image data. For example, assume that the pinch operation is performed on image data P 7001 shown in FIG. 7A to enlarge it and, as a result, an area 7002 is identified as an area to be enlarged and that the area 7002 is enlarged to the full screen of the touch panel 1002 as shown by image data 7003 in FIG. 7A. Also assume that the coordinates of the top-left corner and the coordinates of bottom-right corner of the touch panel 1002 take the following values:

Coordinates of top-left corner=(30, 40), Coordinates of bottom-right corner=(90, 90)
Similarly, enlarged and displayed image data, such as the image data 7003 shown in FIG. 7A, can be reduced by the pinch operation and displayed as image data such as the image data 7001.

In step S405, the acquisition unit 1016 detects the persons in the enlarged or reduced image data based on the metadata associated with the enlarged or reduced image data. For example, in the example in FIG. 7A, the acquisition unit 1016 detects that persons A and B are in the enlarged image data 7003 based on the metadata 2002 associated with the image data P. In step S406, for the persons in the enlarged or reduced image data, the acquisition unit 1016 recalculates the matching degree between the image data and each image data stored in the holding unit 1015 using the method described above. For example, in the example in FIG. 7A, the acquisition unit 1016 recalculates the matching degree between the image data and each image data stored in the holding unit 1015 for persons A and B in the enlarged image data using the method described above. At this time, the displayed image data 7003 enlarged by the user's pinch operation is an area of the image data 7001. This area is created by excluding a part in which the user does not have an interest and by selecting the area 7002 in which the user has a particular interest. The user can indicate an area, which includes only the interested persons selected from those in the image data 7001, by performing an intuitive operation in which the area is enlarged to the full screen of the touch panel 1002 to prevent the uninterested persons from being displayed. Similarly, the user can perform the pinch operation to reduce the image data displayed on the touch panel 1002 to increase the number of persons displayed in the full screen of the touch panel 1002. In this case, too, the user can indicate a person in the image displayed on the touch panel 1002 as an interested object by performing an intuitive operation.

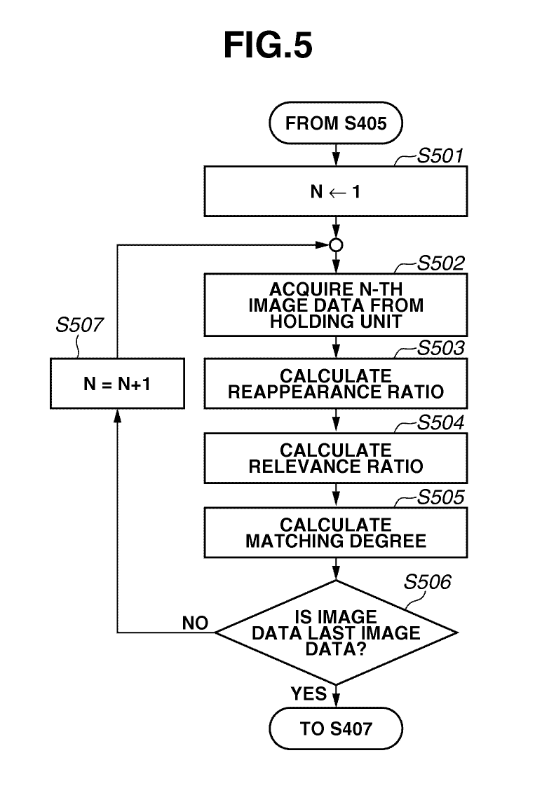

FIG. 5 is a flowchart illustrating the matching degree calculation processing. In step S501, the acquisition unit 1016 sets the counter N, used for sequentially acquiring image data from the holding unit 1015, to 1. In step S502, the acquisition unit 1016 acquires the N-th image data from the holding unit 1015. In step S503, if the N-th image data is the image data Q indicated by the metadata 3001 in FIG. 3, the acquisition unit 1016 calculates the recall as follows based on the number of persons who are included in the enlarged image data P and who are included also in the image data Q:

Recall=2 persons (=A,B)/2 persons (=number of persons in enlarged image data P)=1

In step S504, the acquisition unit 1016 calculates the precision as follows based on the number of persons who are included in the image data Q and who are included also in the enlarged image data P:

Precision=2 persons (=A,B)/2 persons (=number of persons in image data Q)=1

In step S505, the acquisition unit 1016 calculates the matching degree between the enlarged image data P and the image data Q as follows:

Matching degree between enlarged image data P and image data Q=Recall×Precision=1×1=1

In step S506, the acquisition unit 1016 determines whether the image data being processed is the last image data stored in the holding unit 1015. If the image data is the last image data (YES in step S506), the processing proceeds to step S407. On the other hand, if the image data is not the last image data (NO in step S506), the processing proceeds to step S507. In step S507, the acquisition unit 1016 adds 1 to the counter N. After that, the processing returns to step S502 and the acquisition unit 1016 performs the processing for the next image data.

In step S503, if the next image data is the image data R indicated by the metadata 3002 in FIG. 3, the acquisition unit 1016 calculates the recall as follows based on the number of persons who are included in the enlarged image data P and who are included also in the image data R:

Recall=2 persons (=A,B)/2 persons (=number of persons in enlarged image data P)=1

In step S504, the acquisition unit 1016 calculates the precision as follows based on the number of persons who are included in the image data R and who are included also in the enlarged image data P:

Precision=2 persons (=A,B)/3 persons (=number of persons in image data R)=2/3

In step S505, the acquisition unit 1016 calculates the matching degree between the enlarged image data P and the image data R as follows:

Matching degree between enlarged image data P and image data R=Recall×Precision=1×2/3=2/3

In step S503, if the next image data is the image data S indicated by the metadata 3003 in FIG. 3, the acquisition unit 1016 calculates the recall as follows based on the number of persons who are included in the enlarged image data P and who are included also in the image data S:

Recall=1 person (=B)/2 persons (=number of persons in enlarged image data P)=1/2

In step S504, the acquisition unit 1016 calculates the precision as follows based on the number of persons who are included in the image data S and who are included also in the enlarged image data P:

Precision=1 person (=B)/2 persons (=number of persons in image data S)=1/2

In step S505, the acquisition unit 1016 calculates the matching degree between the enlarged image data P and the image data S as follows:

Matching degree between enlarged image data P and image data S=Recall×Precision=1/2×1/2=1/4

After the matching degree is calculated to the last image data as described above, the processing proceeds to step S407.

In step S407, the acquisition unit 1016 acquires only the image data whose matching degree recalculated as described above is greater than or equal to the threshold (for example, greater than or equal to ½), from the image data stored in the holding unit 1015. The order determination unit 1018 sequentially stores the image data, acquired by the acquisition unit 1016, in the positions [0], [1], [2], [3], and [4] in the cache 2011 in descending order of the matching degree. In this way, the image data stored in the cache 2011 and its storing order are changed as shown in FIG. 7B. After that, when the user performs the flick operation to move the image data to the left, the image data stored in the cache 2011 has already been changed and, therefore, the image data that is displayed next is not the image data that is displayed next before the image data P is enlarged. The enlarged image data P includes only persons A and B but not person C. In other words, it is thought that the user has an interest on persons A and B but not on person C. After the image data P is enlarged, the order is determined so that the image data including persons A and B are arranged near to the position [0] in the cache 2011 and so the user can quickly find the image data near to user's interest.

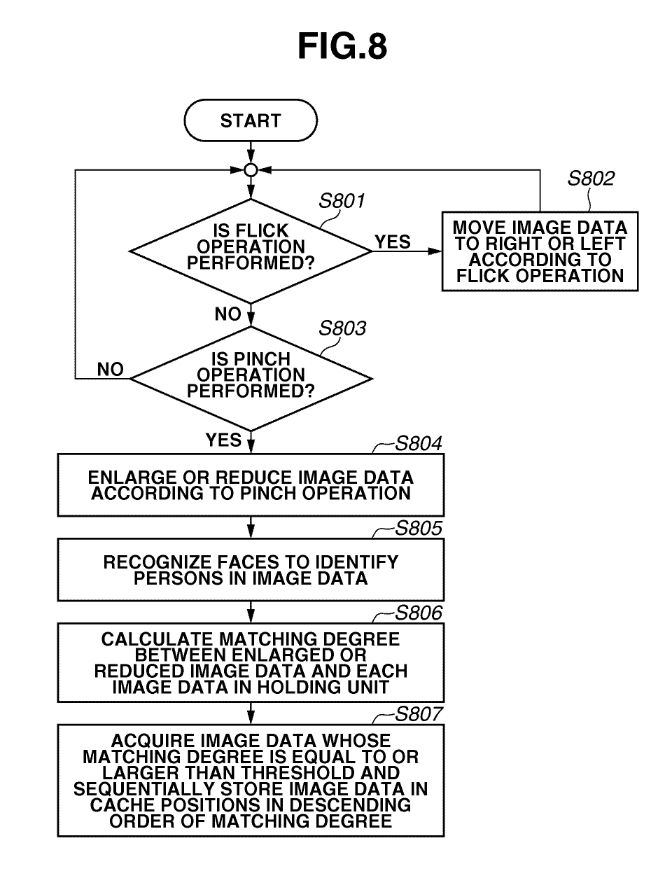

While the present exemplary embodiment describes that metadata on the persons in image data is attached to the image data in advance, object recognition such as face recognition may also be performed at image data browsing time. FIG. 8 is a flowchart illustrating the processing in which object recognition is performed at image data browsing time. The processing in steps S801 to S804 and steps S806 to S807 is the same as that in steps S401 to S404 and steps S406 to S407 in FIG. 4, thus a detailed description is omitted herein. In step S805, the mobile phone recognizes the faces in an area 7002 of the image data in FIG. 7A to identify the persons. The mobile phone also recognizes the faces in each image data stored in the holding unit 1015. Because a state similar to the state in which metadata is attached in advance is created in this step, image data in the cache 2011 can be rearranged in the same way as described above.

Although the matching degree is calculated based on the recall and the precision in the present exemplary embodiment, the calculation method of the matching degree is not limited to this method. For example, the matching degree may be calculated according to how many persons in the area 7002 match the persons in the target image data. In this case, the matching degree between the enlarged image data P (=A and B are in the image data) and the image data Q (=A and B are in the image data) is 2 (=A and B), and the matching degree between the enlarged image data P and the image data R (=A, B, and C are in the image data) is also 2 (=A and B). When the recall and the precision are used, the matching degree of the image data Q is determined to be higher than the matching degree of the image data R as described above. This is because the matching degree is reduced by the fact that the image data R includes person C who is not in the enlarged image data P. This means that using the recall and the precision allows the matching degree to be calculated more accurately.

Although the image data is stored in the holding unit 1015 (memory card 1025) and the image data, whose matching degree is greater than or equal to the threshold, is stored in the cache 2011 in the present exemplary embodiment, the image data may also be stored in a location other than the holding unit 1015 (memory card 1025). For example, image data may be stored on a network server, where a user can access the image date via a network. In this case, image data may be displayed according to the order based on the matching degree without using the cache 2011. As far as the display order is determined based on the matching degree, this method also achieves the effect that the user can quickly find image data correlating to the user's interest. However, storing image data in the cache 2011 provides the user with some additional effects. One is that image data stored in the cache 2011 can be displayed more quickly when moved horizontally. Another is that selecting image data with a matching degree greater than or equal to the threshold reduces the amount of memory usage. In addition, while image data in the present exemplary embodiment is scrolled using a flick operation, the image may also be scrolled using a key or voice input.

As described above, in the present exemplary embodiment, image data related to a user's interested area can be preferentially displayed without cumbersome operations.

Next, a second exemplary embodiment is described. In the first exemplary embodiment, the coordinate positions of the persons in the image data are used as the coordinate positions of the persons in the metadata as shown in the metadata 2002 in FIG. 2A. In this case, even if the greater part of person A and a part of person B are displayed as shown by the image data 7003 in FIG. 7A, person A and person B are processed equally and, based on the result of the matching degree calculation, the contents of the cache 2011 are rearranged. However, when the user enlarges and displays the image data as shown by the image data 7003 in FIG. 7A, the user seems to have a greater interest in person A. Therefore, rearranging the contents of the cache 2011 so that the image data including person A is placed nearer to the position [0] than the image data including person B allows the user to search for desired image data more efficiently.

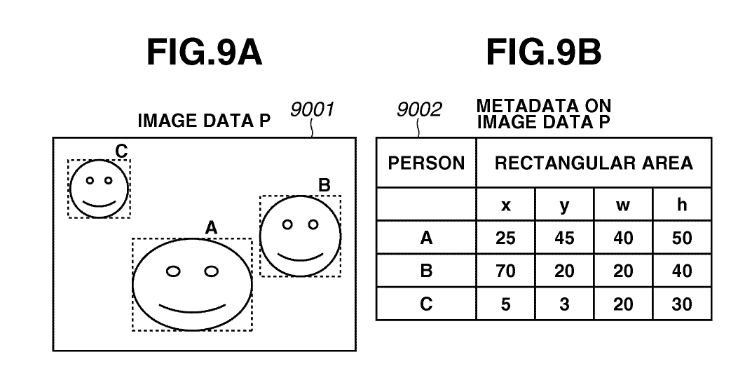

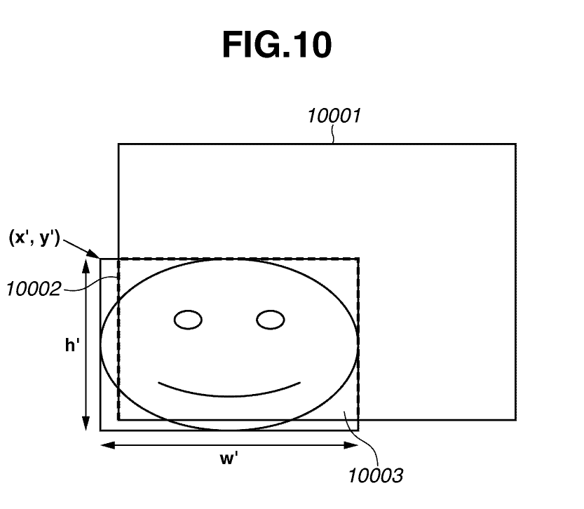

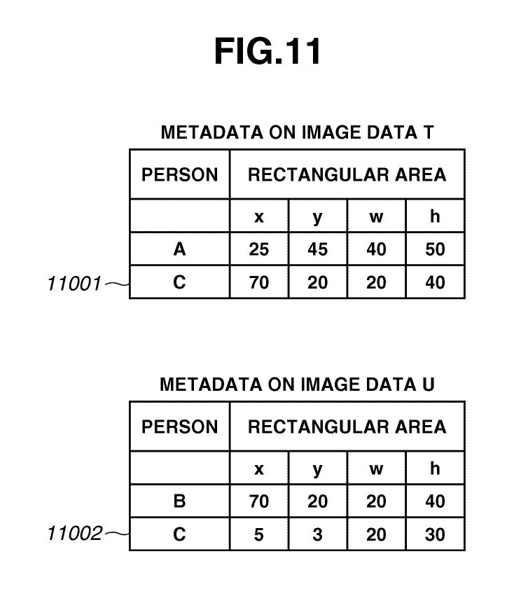

The area enclosing each object corresponding to a person in the image data is represented by a rectangular area such as the one indicated by the dotted line in image data 9001 in FIG. 9A, and the metadata such as the one indicated by metadata 9002 in FIG. 9B is assigned to the image data. FIG. 10 shows a part of person A that is displayed when the image data is enlarged as shown by the image data 7003 in FIG. 7A. The touch panel 1002 has an area 10001, which includes a rectangular area 10002 of person A. When the enlargement operation is performed, the values (x′,y′,w′,h′) are obtained from the rectangular information (x,y,w,h) on person A that is recorded in the format shown by the metadata 9002. An area 10003 is an area that is a part of the rectangular area of the person and that is displayed on the touch panel 1002. From these values, the acquisition unit 1016 acquires a display ratio (third acquisition). This display ratio is the ratio of the area of the rectangular area of person A actually displayed on the touch panel 1002 to the area of the rectangular area of person A. For example, assume that the acquired display ratio of person A is 0.9. Also assume that, for person B, the display ratio of the area of the rectangular area of person B actually displayed on the touch panel 1002 to the area of the rectangular area of person B is, for example, 0.6. The holding unit 1015 stores the image data T, to which metadata 11001 in FIG. 11 is attached, and the image data U to which metadata 11002 in FIG. 11 is attached. The acquisition unit 1016 calculates the matching degree between the image data P and the image data T as follows.

The image data T includes only person A, one of the two persons A and B in the enlarged image data P. Therefore, the acquisition unit 1016 calculates the recall and the precision as follows:

Recall=0.9 (=display ratio of A)/2 persons (=number of persons in enlarged image data P)=0.45

Precision=0.9 (=display ratio of A)/2 persons (number of persons in image data T)=0.45

From the recall and the precision calculated as described above, the acquisition unit 1016 calculate the matching degree between the image data P and the image data T as follows:

Matching degree between image data P and image data T=Recall×Precision=0.45×0.45≈0.2

On the other hand, the image data U includes only person B, one of the two persons A and B in the enlarged image data P. Therefore, the acquisition unit 1016 calculates the recall and the precision as follows:

Recall=0.6 (display ratio of B)/2 persons (number of persons in enlarged image data P)=0.3

Precision=0.6 (=display ratio of B)/2 persons (=number of persons in image data U)=0.3

From the recall and the precision calculated as described above, the acquisition unit 1016 calculates the matching degree between the image data P and the image data U as follows:

Matching degree between image data P and image data U=Recall×Precision=0.3×0.3≈0.09

As described above, the matching degree between the image data P and the image data T is larger than the matching degree between the image data P and the image data U. Therefore, the order determination unit 1018 determines the order so that, in the cache 2011, the image data T is placed nearer to the image data P than the image data U. When the user enlarges the image data P, as shown by the image data 7003 in FIG. 7A, the order determined in this way because the user has more interest in person A than in person B. The matching degree is determined as ½ for both image data T and image data U in the first exemplary embodiment. In the present exemplary embodiment, the image data display order is determined to reflect the user's interest.

Although metadata associated with the persons in image data is attached to the image data in advance in the present exemplary embodiment as in the first exemplary embodiment, the face recognition processing can be performed at image data browsing time. While image data in the present exemplary embodiment is scrolled using a flick operation, the image data can be scrolled using a key press or voice input.

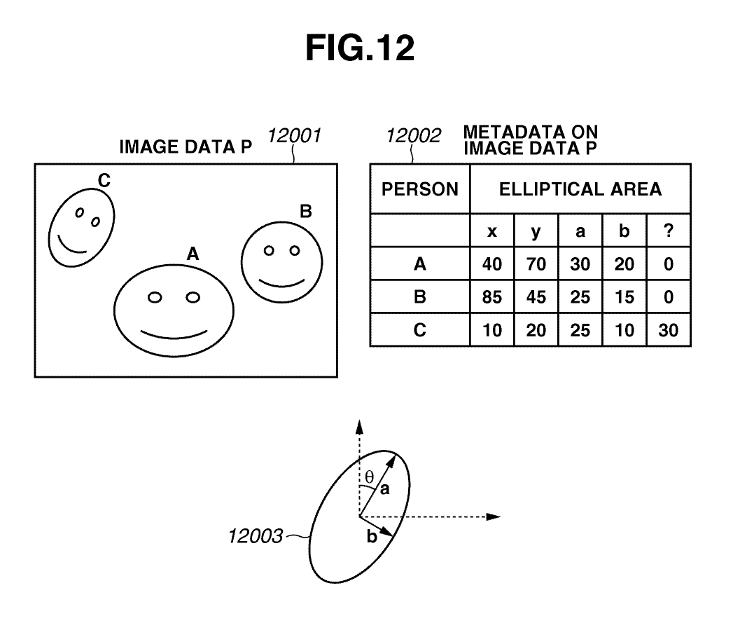

A third exemplary embodiment will now be described. In the second exemplary embodiment, the information indicating the rectangular area of a person in image data is stored as metadata. However, when a photograph is taken with the face of a person tilted, as with person C indicated by image data 12001 in FIG. 12, the area, if represented as a rectangular area, becomes larger than the area actually occupied by the person, reducing the accuracy of the matching degree calculation that is based on the display ratio. In order to address this, a person is approximated, not by a rectangular area, but by an elliptical area. In this case, the information on the elliptical area is used as the metadata. This increases the accuracy of the matching degree calculation based on the display ratio. The information indicating the elliptical area is represented by the center coordinates (x,y), lengths of major axis and minor axis a and b, and the slope θ as shown by an ellipse 12003 in FIG. 12. This information is stored in the format as shown by metadata 12002 in FIG. 12. For this ellipse, the acquisition unit 1016 calculates the display ratio of the elliptical area of a person actually displayed on the touch panel 1002 to the area of each elliptical area of the object of the person, as well as the matching degree, as described in the second exemplary embodiment. After that, the order determination unit 1018 determines the order in which the image data held in the cache 2011 is to be displayed.

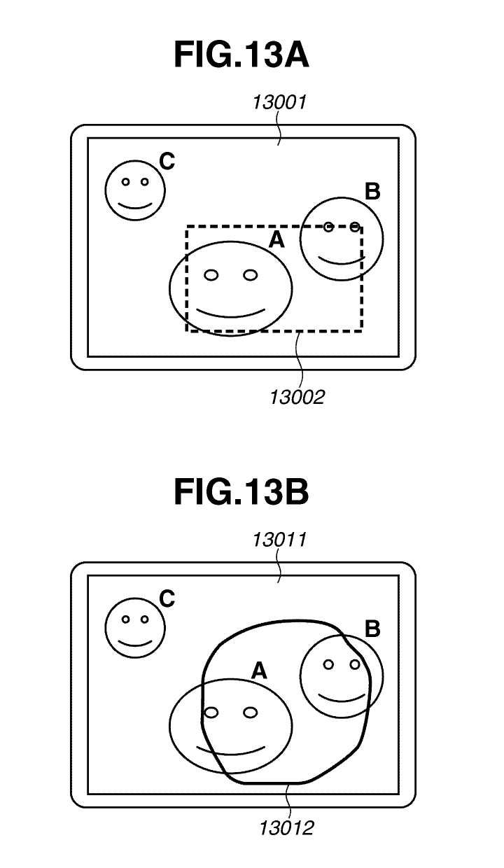

A fourth exemplary embodiment will now be described. While the user performs multi-touch-based pinch operation to enlarge or reduce image data in the first to third exemplary embodiments, the fourth exemplary embodiment provides additional methods in which to enlarge or reduce image data. A dialog for entering an enlargement ratio or a reduction ratio may be displayed to prompt the user to enter the numeric value of an enlargement ratio or a reduction ratio or to speak “enlarge” or “reduce” to specify the enlargement/reduction operation via voice. Another method is to display a display frame, such as the one shown by a frame 13002 in FIG. 13A, to allow the user to specify this display frame to enlarge the range of the frame to correspond to the full screen of the touch panel 1002. Still yet another method is a handwritten input to the touch panel 1002, in which case the user manually specifies the area of an object to be enlarged as shown by an area 13012 in FIG. 13B.

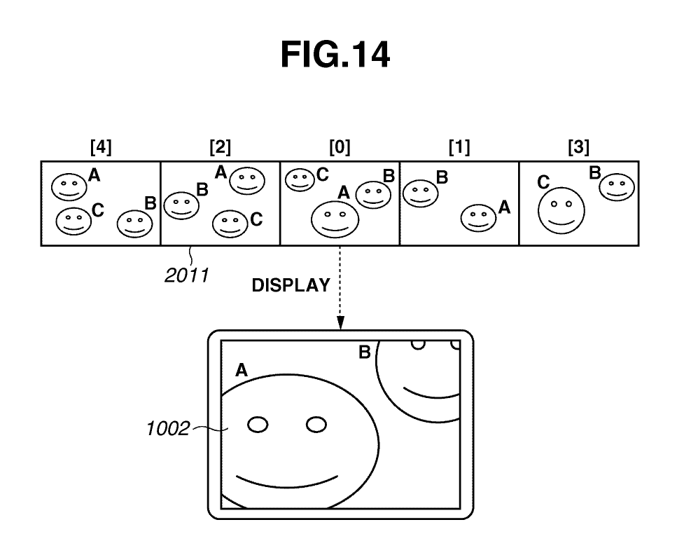

A fifth exemplary embodiment will now be described. While the order determination unit 1018 determines to display image data in descending order of the matching degree in the first exemplary embodiment, the image data need not be displayed in descending order. In the present exemplary embodiment, for example, the order determination unit 1018 may determine to display image data in ascending order of the matching degree. This is useful to search for image data including a specific area that does not include any person. In addition, as shown in FIG. 14, the order determination unit 1018 may place image data in ascending order of the matching degree alternately on the left side and on the right side of the image data being displayed.

Although only one target area is specified as a target area to be enlarged or reduced and displayed in the first to third exemplary embodiments, two or more target areas may also be specified. Although a person, its position information, and its area information are used as the object information in the first to third exemplary embodiments, a non-person object may also be used. Depth information and color information may also be used in addition to the object position information and the object area information. The area may be any closed area, not just a rectangular area or an elliptical area.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium). In such a case, the system or apparatus, and the recording medium where the program is stored, are included as being within the scope of the present invention.

The exemplary embodiments described above enable the user to preferentially display the image data related to a region of user's interest without cumbersome operations.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-084020 filed Apr. 5, 2011, which is hereby incorporated by reference herein in its entirety.

What is claimed is:

1. An information processing device comprising:
a memory; and
a processor, coupled to the memory, the processor configured to control:
a display control unit configured to enlarge or reduce and display an area of a part of image data, displayed on a display unit, in response to a user operation; and
a determination unit configured to, based on objects included in the area enlarged or reduced and displayed by the display control unit and on objects included in a plurality of image data pieces, determine a display order of the plurality of image data pieces.

2. The information processing device according to claim 1, wherein the area enlarged or reduced and displayed by the display control unit includes a plurality of objects, and
wherein the determination unit is configured to, based on the plurality of objects included in the area and a plurality of objects included in the image data, determine the display order of the plurality of image data pieces.

3. The information processing device according to claim 2, wherein the processor further controls:
a first acquisition unit configured to acquire information on a number of the plurality of objects that are included in the area enlarged or reduced and displayed by the display control unit and that are included also in the plurality of image data pieces; and
a second acquisition unit configured to acquire information on a number of the plurality of objects that are included in the image data pieces and that are also included in the area,
wherein the determination unit is configured to, based on the information acquired by the first acquisition unit and the second acquisition unit, determine the display order of the plurality of image data pieces.

4. The information processing device according to claim 3, wherein the determined order is such that image data is preferentially displayed among the plurality of image data pieces, the image data including more objects that are the plurality of objects included in the area and that are also included in the image data and including more objects that are the plurality of objects included in the image data and that are also included in the area.

5. The information processing device according to claim 2, wherein the processor further controls:
a third acquisition unit configured to acquire a display ratio for each of the plurality of objects included in the area enlarged or reduced and displayed by the display control unit, the display ratio being a ratio of the object displayed on the display unit,
wherein the determination unit is configured to, based on the display ratio acquired by the third acquisition unit, determine the display order of the plurality of image data pieces.

6. The information processing device according to claim 1, wherein information indicating objects included in the image data is attached to the image data as metadata in advance.

7. The information processing device according to claim 1, wherein information indicating objects included in the image data pieces is information obtained from the image data by recognizing the objects.

8. The information processing device according to claim 7, wherein the determined display order is determined in such a way that image data is preferentially displayed among the plurality of objects included in the area, the image data including an object with a high display ratio of the object displayed on the display unit.

9. The information processing device according to claim 8, wherein information indicating an area enclosing the object is attached to the image data as metadata in advance.

10. The information processing device according to claim 8, wherein information indicating an area enclosing the object is information obtained from the image data by recognizing the object.

11. The information processing device according to claim 2, wherein the processor further controls:
a cache unit configured to hold image data included in the plurality of image data pieces and that is to be preferentially displayed,
wherein the determination unit is configured to determine the display order of the image data held in the cache unit.

12. An information processing method comprising:
enlarging or reducing and displaying an area of a part of image data, displayed on a display unit, in response to a user operation; and
determining, based on objects included in the enlarged or reduced and displayed area and on objects included in a plurality of image data pieces, a display order of the plurality of image data pieces.

13. The information processing method according to claim 12, wherein the enlarged or reduced and displayed area includes a plurality of objects, the information processing method further comprising:
determining, based on the plurality of objects included in the area and a plurality of objects included in the image data, the display order of the plurality of image data pieces.

14. The information processing method according to claim 13 further comprising:
acquiring first information on a number of the plurality of objects that are included in the enlarged or reduced and displayed area and that are also included in the plurality of image data pieces;
acquiring second information on a number of the plurality of objects that are included in the image data and that are also included in the area; and
determining, based on the first information and the second information, the display order of the plurality of image data pieces.

15. The information processing method according to claim 13 further comprising:
acquiring a display ratio for each of the plurality of objects included in the enlarged or reduced and displayed area, the display ratio being a ratio of the object displayed on the display unit; and
determining, based on the acquired display ratio, the display order of the plurality of image data pieces.

16. A computer readable storage medium storing a program that causes a computer to perform a method, the information processing method comprising:
enlarging or reducing and displaying an area of a part of image data, displayed on a display unit, in response to a user's operation; and
determining, based on objects included in the enlarged or reduced and displayed area and on objects included in a plurality of image data pieces, a display order of the plurality of image data pieces.

17. The computer readable storage medium according to claim 16, wherein the enlarged or reduced and displayed area includes a plurality of objects, the method further comprising:
determining, based on the plurality of objects included in the area and a plurality of objects included in the image data, the display order of the plurality of image data pieces.

18. The computer readable storage medium according to claim 17, the method further comprises:
acquiring first information on a number of the plurality of objects that are included in the enlarged or reduced and displayed area and that are also included in the plurality of image data pieces;
acquiring second information on a number of the plurality of objects that are included in the image data and that are also included in the area; and
determining, based on the first information and the second information, the display order of the plurality of image data pieces.

19. The computer readable storage medium according to claim 17, the method further comprising:
acquiring a display ratio for each of the plurality of objects included in the enlarged or reduced and displayed area, the display ratio being a ratio of the object displayed on the display unit; and
determining, based on the acquired display ratio, the display order of the plurality of image data pieces.
